(19) United States
(12) Patent Application Publication
(10) Pub. No.: US 2025/0225514 A1
(43) Pub. Date: Jul. 10, 2025

(54) System, Method, and Computer Program Product for Preventing Miner Extractable Value (MEV) Attacks in a Blockchain Network

(71) Applicant: Visa International Service Association, San Francisco, CA (US)

(72) Inventors: Mohammad Mohsen Minaei Bidgoli, San Jose, CA (US); Ranjit Kumaresan, Fremont, CA (US); Yibin Yang, Atlanta, GA (US); Sourav Das, Champaign, IL (US); Srinivasan Raghuraman, Cambridge, MA (US); Mahdi Zamani, Mercer Island, WA (US); Mihai Christodorescu, Belmont, CA (US); Wanyun Gu, Menlo Park, CA (US)

(21) Appl. No.: 18/847,710

(22) PCT Filed: Jun. 22, 2023
(86) PCT No.: PCT/US23/25957

§ 371 Date: Sep. 17, 2024

Related U.S. Application Data
(60) Provisional application No. 63/354,301, filed on Jun. 22, 2022.

(51) Int. Cl. G06Q 20/40; G06Q 20/38

(52) U.S. Cl. CPC G06Q 20/401; G06Q 20/382

(57) ABSTRACT

Provided is a system, method, and computer program product for preventing MEV attacks in a blockchain network. The system includes at least one processor programmed or configured to communicate a plurality of digests to each mining node of a plurality of mining nodes in a blockchain network, each digest of the plurality of digests generated based on a transaction request including transaction data without including the transaction data in each digest, receive, from at least one mining node of the plurality of mining nodes, block data generated based on a proof-of-work protocol and at least a portion of digests of the plurality of digests, request the transaction data for each transaction request of a plurality of transaction requests corresponding to the at least a portion of digests, and publish a new block to the blockchain network based on the transaction data and the block data.

### CROSS REFERENCE TO RELATED APPLICATIONS

This application is the United States national phase of International Patent Application No. PCT/US23/25957 filed on Jun. 22, 2023, and claims the benefit of U.S. Provisional Patent Application No. 63/354,301 filed on Jun. 22, 2022, the disclosures of which are hereby incorporated by reference in their entireties.

### BACKGROUND

### 1. Technical Field

This disclosure relates generally to blockchain networks and, in non-limiting embodiments, systems, methods, and computer program products for preventing Miner Extractable Value (MEV) attacks in a blockchain network.

### 2. Technical Considerations

In blockchain networks that operate off of a proof-of-work protocol, when a transaction requestor wants to publish a transaction to the blockchain, they send it to a memory pool (e.g., “mempool”) of mining nodes. The mining nodes select transactions from the mempool, assemble it into a block, and then perform proof-of-work.

Mining nodes may operate to maximize the MEV from processing the transaction requests into blocks. In some examples, colluding miner nodes may launch an “MEV attack” to increase their earnings, including “front-running” (e.g., using bots to quote higher “gas fees”) or copying an arbitrage trade with the mining node as the recipient (as opposed to the original transaction requestor).

### SUMMARY

According to non-limiting embodiments or aspects, provided is a method comprising: communicating, with at least one processor, a plurality of digests to each mining node of a plurality of mining nodes in a blockchain network, each digest of the plurality of digests generated based on a transaction request comprising transaction data without including the transaction data in the digest; receiving, with the at least one processor from at least one mining node of the plurality of mining nodes, block data generated based on a proof-of-work protocol and at least a portion of digests of the plurality of digests; requesting, with the at least one processor, the transaction data for each transaction request of a plurality of transaction requests corresponding to the at least a portion of digests; and publishing, with the at least one processor, a new block to the blockchain network based on the transaction data and the block data.

In non-limiting embodiments or aspects, the method further comprises: receiving, with the at least one processor, a plurality of transaction requests; and generating the plurality of digests based on the plurality of transaction requests. In non-limiting embodiments or aspects, the method further comprises: determining a subset of transaction requests of the plurality of transaction requests based on a plurality of bids associated with the plurality of transaction requests, each digest of the plurality of digests corresponding to a transaction request of the subset of transaction requests. In non-limiting embodiments or aspects, the at least one mining node is a single mining node. In non-limiting embodiments or aspects, the transaction data is requested for each transaction request in response to receiving the block data generated based on the proof-of-work protocol. In non-limiting embodiments or aspects, the method further comprises: allocating a reward to an address corresponding to the at least one mining node in response to receiving the block data generated based on the proof-of-work protocol. In non-limiting embodiments or aspects, the reward is allocated as a Layer 2 transaction on the blockchain network. In non-limiting embodiments or aspects, the method further comprises: in response to a transaction requestor cancelling a transaction request, issuing a penalty to the transaction requestor.

According to non-limiting embodiments or aspects, provided is a system comprising at least one processor programmed or configured to: communicate a plurality of digests to each mining node of a plurality of mining nodes in a blockchain network, each digest of the plurality of digests generated based on a transaction request comprising transaction data without including the transaction data in the digest; receive, from at least one mining node of the plurality of mining nodes, block data generated based on a proof-of-work protocol and at least a portion of digests of the plurality of digests; request the transaction data for each transaction request of a plurality of transaction requests corresponding to the at least a portion of digests; and publish a new block to the blockchain network based on the transaction data and the block data.

In non-limiting embodiments or aspects, the at least one processor further programmed or configured to: receive a plurality of transaction requests; and generate the plurality of digests based on the plurality of transaction requests. In non-limiting embodiments or aspects, the at least one processor further programmed or configured to: determine a subset of transaction requests of the plurality of transaction requests based on a plurality of bids associated with the plurality of transaction requests, each digest of the plurality of digests corresponding to a transaction request of the subset of transaction requests. In non-limiting embodiments or aspects, the at least one mining node is a single mining node. In non-limiting embodiments or aspects, the transaction data is requested for each transaction request in response to receive the block data generated based on the proof-of-work protocol. In non-limiting embodiments or aspects, the at least one processor further programmed or configured to: allocating a reward to an address corresponding to the at least one mining node in response to receive the block data generated based on the proof-of-work protocol. In non-limiting embodiments or aspects, the reward is allocated as a Layer 2 transaction on the blockchain network. In non-limiting embodiments or aspects, the at least one processor further programmed or configured to: in response to a transaction requestor cancelling a transaction request, issue a penalty to the transaction requestor.

According to non-limiting embodiments or aspects, provided is a computer program product comprising at least one non-transitory computer-readable medium including program instructions that, when executed by at least one processor, cause the at least one processor to: communicate a plurality of digests to each mining node of a plurality of mining nodes in a blockchain network, each digest of the plurality of digests generated based on a transaction request comprising transaction data without including the transaction data in the digest; receive, from at least one mining node of the plurality of mining nodes, block data generated based on a proof-of-work protocol and at least a portion of digests of the plurality of digests; request the transaction data for each transaction request of a plurality of transaction requests corresponding to the at least a portion of digests; and publish a new block to the blockchain network based on the transaction data and the block data.

In non-limiting embodiments or aspects, the at least one processor further programmed or configured to: receive a plurality of transaction requests; and generate the plurality of digests based on the plurality of transaction requests. In non-limiting embodiments or aspects, the at least one processor further programmed or configured to: determine a subset of transaction requests of the plurality of transaction requests based on a plurality of bids associated with the plurality of transaction requests, each digest of the plurality of digests corresponding to a transaction request of the subset of transaction requests. In non-limiting embodiments or aspects, the at least one mining node is a single mining node. In non-limiting embodiments or aspects, the transaction data is requested for each transaction request in response to receive the block data generated based on the proof-of-work protocol. In non-limiting embodiments or aspects, the at least one processor further programmed or configured to: allocating a reward to an address corresponding to the at least one mining node in response to receive the block data generated based on the proof-of-work protocol. In non-limiting embodiments or aspects, the reward is allocated as a Layer 2 transaction on the blockchain network. In non-limiting embodiments or aspects, the at least one processor further programmed or configured to: in response to a transaction requestor cancelling a transaction request, issue a penalty to the transaction requestor.

Other non-limiting embodiments or aspects will be set forth in the following numbered clauses:

Clause 1: A method comprising: communicating, with at least one processor, a plurality of digests to each mining node of a plurality of mining nodes in a blockchain network, each digest of the plurality of digests generated based on a transaction request comprising transaction data without including the transaction data in the digest; receiving, with the at least one processor from at least one mining node of the plurality of mining nodes, block data generated based on a proof-of-work protocol and at least a portion of digests of the plurality of digests; requesting, with the at least one processor, the transaction data for each transaction request of a plurality of transaction requests corresponding to the at least a portion of digests; and publishing, with the at least one processor, a new block to the blockchain network based on the transaction data and the block data.

Clause 2: The method of clause 1, further comprising: receiving, with the at least one processor, a plurality of transaction requests; and generating the plurality of digests based on the plurality of transaction requests.

Clause 3: The method of clauses 1 or 2, further comprising: determining a subset of transaction requests of the plurality of transaction requests based on a plurality of bids associated with the plurality of transaction requests, each digest of the plurality of digests corresponding to a transaction request of the subset of transaction requests.

Clause 4: The method of any of clauses 1-3, wherein the at least one mining node is a single mining node.

Clause 5: The method of any of clauses 1-4, wherein the transaction data is requested for each transaction request in response to receiving the block data generated based on the proof-of-work protocol.

Clause 6: The method of any of clauses 1-5, further comprising: allocating a reward to an address corresponding to the at least one mining node in response to receiving the block data generated based on the proof-of-work protocol.

Clause 7: The method of any of clauses 1-6, wherein the reward is allocated as a Layer 2 transaction on the blockchain network.

Clause 8: The method of any of clauses 1-7, further comprising: in response to a transaction requestor cancelling a transaction request, issuing a penalty to the transaction requestor.

Clause 9: A system comprising at least one processor programmed or configured to: communicate a plurality of digests to each mining node of a plurality of mining nodes in a blockchain network, each digest of the plurality of digests generated based on a transaction request comprising transaction data without including the transaction data in the digest; receive, from at least one mining node of the plurality of mining nodes, block data generated based on a proof-of-work protocol and at least a portion of digests of the plurality of digests; request the transaction data for each transaction request of a plurality of transaction requests corresponding to the at least a portion of digests; and publish a new block to the blockchain network based on the transaction data and the block data.

Clause 10: The system of clause 9, the at least one processor further programmed or configured to: receive a plurality of transaction requests; and generate the plurality of digests based on the plurality of transaction requests.

Clause 11: The system of clauses 9 or 10, the at least one processor further programmed or configured to: determine a subset of transaction requests of the plurality of transaction requests based on a plurality of bids associated with the plurality of transaction requests, each digest of the plurality of digests corresponding to a transaction request of the subset of transaction requests.

Clause 12: The system of any of clauses 9-11, wherein the at least one mining node is a single mining node.

Clause 13: The system of any of clauses 9-12, wherein the transaction data is requested for each transaction request in response to receive the block data generated based on the proof-of-work protocol.

Clause 14: The system of any of clauses 9-13, the at least one processor further programmed or configured to: allocating a reward to an address corresponding to the at least one mining node in response to receive the block data generated based on the proof-of-work protocol.

Clause 15: The system of any of clauses 9-14, wherein the reward is allocated as a Layer 2 transaction on the blockchain network.

Clause 16: The system of any of clauses 9-15, the at least one processor further programmed or configured to: in response to a transaction requestor cancelling a transaction request, issue a penalty to the transaction requestor.

Clause 17: A computer program product comprising at least one non-transitory computer-readable medium including program instructions that, when executed by at least one processor, cause the at least one processor to: communicate a plurality of digests to each mining node of a plurality of mining nodes in a blockchain network, each digest of the plurality of digests generated based on a transaction request comprising transaction data without including the transaction data in the digest; receive, from at least one mining node of the plurality of mining nodes, block data generated based on a proof-of-work protocol and at least a portion of digests of the plurality of digests; request the transaction data for each transaction request of a plurality of transaction requests corresponding to the at least a portion of digests; and publish a new block to the blockchain network based on the transaction data and the block data.

Clause 18: The computer program product of clause 17, the at least one processor further programmed or configured to: receive a plurality of transaction requests; and generate the plurality of digests based on the plurality of transaction requests.

Clause 19: The computer program product of clauses 17 or 18, the at least one processor further programmed or configured to: determine a subset of transaction requests of the plurality of transaction requests based on a plurality of bids associated with the plurality of transaction requests, each digest of the plurality of digests corresponding to a transaction request of the subset of transaction requests.

Clause 20: The computer program product of any of clauses 17-19, wherein the at least one mining node is a single mining node.

Clause 21: The computer program product of any of clauses 17-20, wherein the transaction data is requested for each transaction request in response to receive the block data generated based on the proof-of-work protocol.

Clause 22: The computer program product of any of clauses 17-21, the at least one processor further programmed or configured to: allocating a reward to an address corresponding to the at least one mining node in response to receive the block data generated based on the proof-of-work protocol.

Clause 23: The computer program product of any of clauses 17-22, wherein the reward is allocated as a Layer 2 transaction on the blockchain network.

Clause 24: The computer program product of any of clauses 17-23, the at least one processor further programmed or configured to: in response to a transaction requestor cancelling a transaction request, issue a penalty to the transaction requestor.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for preventing MEV attacks in a blockchain network according to non-limiting embodiments or aspects;

FIG. 2 illustrates example components of a device used in connection with non-limiting embodiments or aspects; and

FIG. 3 is a flow diagram of a method for preventing MEV attacks in a blockchain network according to non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments result in an improved blockchain network that is resistant to MEV attacks. Using the system architecture described here, transactions conducted through the improved blockchain network may be resistant to attacks that may involve front-running, back-running, transaction re-ordering, and sandwich attacks. Moreover, non-limiting embodiments provide a way for new blocks to be published to the blockchain network without exposing transaction data, allowing for certain aspects of transaction data to remain private while still transacting in a blockchain network. Other advantages are realized from non-limiting embodiments described herein.

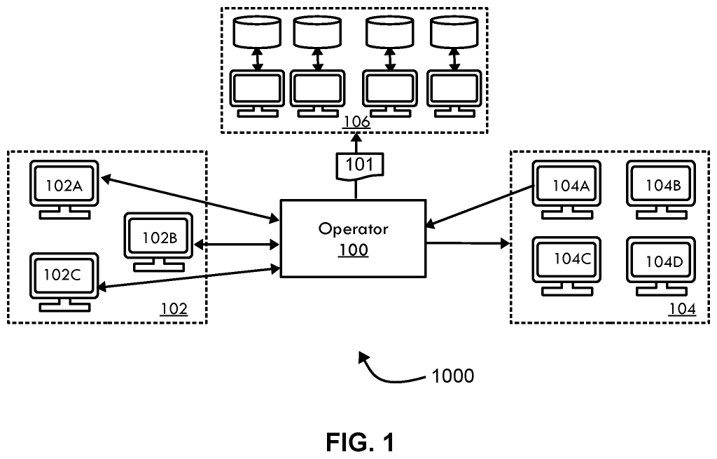

FIG. 1 depicts a system 1000 for preventing MEV attacks in a blockchain network according to non-limiting embodiments or aspects. An operator 100 may include one or more computing devices in communication with a blockchain network 106. In some examples, the operator 100 may be a computing device that operates as a node in the blockchain network 106 (e.g., an administrative node or the like). The operator 100 is in communication with a plurality of transaction requestors 102 (102A, 102B, 102C, etc.) that submit transaction requests (e.g., a request to record a transaction on the blockchain network 106 such that it is part of a distributed ledger maintained by nodes in the blockchain network 106) to the operator 100. The operator may receive a plurality of transaction requests and/or digests based on a plurality of transaction requests. For example, a predetermined or dynamic number of transaction requests may be packaged into a single digest and received from a transaction requestor. In some non-limiting embodiments, the digests may include only a hash of the transaction data and not the transaction data itself. In this manner, the operator 100 may not have access to all of the underlying transaction data.

The blockchain network 106 may, in some examples, be an Ethereum blockchain network. However, it will be appreciated that other blockchain networks may be used, and that such blockchain networks may be public or private in nature. The blockchain network 106 may include a Bitcoin network, a network associated with a different cryptocurrency, and/or the like.

With continued reference to FIG. 1, once the operator 100 obtains the digests representing the transaction requests, the digests can be sent to the memory pool for mining nodes 104 (e.g., 104A, 104B, 104C, 104D, etc.). The mining nodes 104 may include computing devices that operate as cryptocurrency miners in the blockchain network 106. The mining nodes 104 receive the digests and process them, based on the hashed transaction data (e.g., using multi-party computation, secure hardware, and/or the like), to receive a reward (e.g., an amount of cryptocurrency). As an example, the mining nodes 104 may process the digests using a proof-of-work (POW) protocol. When a mining node 104A, 104B, 104C, 104D completes a block (e.g., generates a fully mined block based on a digest), the mining node informs the operator 100. As an example, in FIG. 1, mining node 104A may return a completed block to the operator 100 before mining nodes 104B, 104C, and 104D. In response to receiving the block, the operator 100 may transfer a reward to the successful mining node 104A. In some examples, the reward may be transferred on Layer 2 of the blockchain network 106.

Still referring to FIG. 1, the operator 100, after receiving a completed block from a mining node 104A, informs the transaction requestors 102 that submitted transaction requests included in the processed digest. The actual transaction data for each transaction request may then be sent from the transaction requestors 102 to the operator 100, and the operator 100 may push a block 101 for publication to the blockchain network 106. The transaction requestors 102 may then transfer a payment to the operator 100 (e.g., a “gas fee”). In some non-limiting embodiments, the payment to the operator 100 (and the reward to the successful mining node 104A) may be based on an auction process conducted by the transaction requestors 102, the operator 100, and/or another party. For example, prior to sending the digests to the operator 100, the transaction requestors 102 may enter into an auction process conducted by the operator 100 in which the transaction requestors 102 submit bids for how much they are willing to pay to process a transaction on the blockchain network 106. The operator 100 may implement various rules for determining which bids to accept. For example, the operator 100 may accept the highest predetermined number of bids. The predetermined number of bids may be a number of transactions for a single block.

In non-limiting embodiments, the operator 100 may implement penalties. For example, if a transaction requestor cancels a transaction request after it is submitted in a digest, a penalty may be assessed against the transaction requestor and transferred to the operator 100. Likewise, if the operator 100 fails to successfully publish the block to the blockchain network 106, it may pay a penalty to one or more parties (e.g., all mining nodes 104 and all transaction requestors 102, including non-winners of the auction). Penalties may be transferred on Layer 2 of the blockchain network 106.

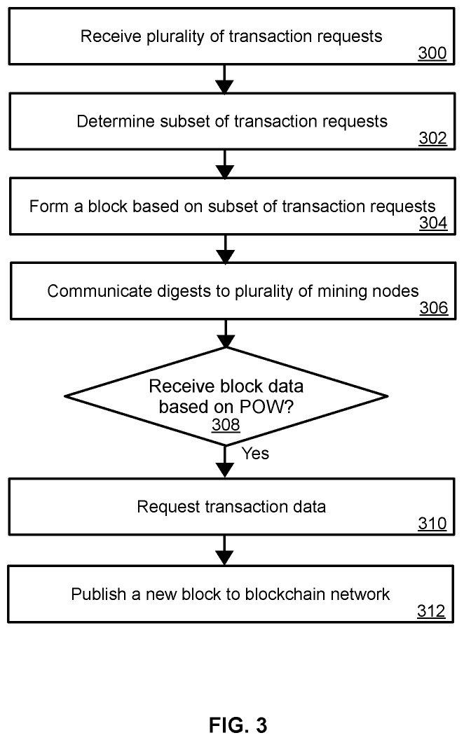

Referring now to FIG. 3, a flow diagram is shown for a method of preventing MEV attacks in a blockchain network according to non-limiting embodiments or aspects. The steps shown in FIG. 3 are for example purposes only. It will be appreciated that different, additional, fewer, and/or a different order of steps may be employed in various embodiments. In non-limiting embodiments, the steps shown in FIG. 3 may be performed automatically without human intervention in response to a preceding step, such that some or all of the flow diagram may be performed automatically. The steps shown in FIG. 3 may be performed by a computing device, such as an operator as described herein. However it will be appreciated that one or more devices, entities, and/or systems may perform one or more steps shown in FIG. 3.

At step 300 of FIG. 3, a plurality of transaction requests are received from entities requesting the transactions to be performed (e.g., transaction requestors). The transaction requests may request, for example, transfer of a specified amount of digital currency from a first address on the blockchain network to a second address on the blockchain network. It will be appreciated that various types of requests may be involved in different non-limiting embodiments. The transaction requests may be hashed to form a digest from transaction data that includes, as an example, one or more bids, a transaction amount, a payee address, a payor address, and/or the like. The requests may be received through a blockchain network or external to a blockchain network. At step 302, a subset of transaction requests of the plurality of transaction requests (and/or digests) are determined based on a plurality of bids associated with the plurality of transaction requests (e.g., included in the transaction requests).

With continued reference to FIG. 3, at step 304 a block may be formed (e.g., generated) based on the subset of transaction requests and/or digests determined at step 302. Each digest of the plurality of digests may correspond to a transaction request of the subset of transaction requests determined at step 302. The block formed at step 304 may include a plurality of digests corresponding to transaction requests with the highest bids and the digests may be generated by the transaction requestors in a manner that hides the underlying transaction data (e.g., via a hash). The plurality of digests corresponding to the block formed at step 304 may then be communicated to a plurality of mining nodes in a blockchain network at step 306.

Still referring to FIG. 3, at step 308 it is determined if block data is received based on a POW protocol performed by one of the mining nodes. The block data may be generated by the mining nodes based on at least a portion of the digests of the plurality of digests and a POW algorithm, resulting in a solution that can be communicated to prove that it engaged in successfully processing the digests. In response to block data being received at step 308, the flow continues to step 310.

In non-limiting embodiments, steps 300-308 may be part of an auction process (e.g., a mempool auction) in which the transaction requestors that communicate the plurality of transaction requests received at step 300 with one or more bids, such that the subset of transaction requests determined at step 302 are based on the bids. For example, a highest portion of bids may be part of the subset. In some examples, step 302 involves determining the top k bids. The bids represent a cost (e.g., a “gas” amount) that the transaction requestors are willing to spend.

In non-limiting embodiments, the mining node that first solves the POW based on the digests (e.g., the winner of the mining pool), the mining node may get paid right away from the operator, such that the operator is the direct payor and an amount of digital currency may be transferred to the mining node. In some examples, the reward digital currency for solving the POW may be sent on Layer 2 of the blockchain protocol, as an example, for speed and lack of expense.

At step 310 of FIG. 3, the transaction data is requested for each transaction request of the subset of transaction requests (e.g., corresponding to the at least a portion of the digests processed by the mining nodes). Before receiving such data, neither the minor nor the operator has all of the underlying transaction data for each transaction request. The transaction data is requested from the transaction requestor(s) with the accepted bids so that the transaction can be conducted. At step 312, a new block is generated and published to the blockchain network based on the block data received at step 308. If a transaction requestor aborts or is non-responsive at step 310, it may be penalized by having an amount of digital currency transferred to the operator automatically by way of a smart contract on the blockchain network. If the operator does not publish the block, then it may pay a penalty to all miners and all transaction requestors (including non-winning transaction requestors). Other possibilities for penalties may be specified among the parties via a smart contract or the like. In some examples, the penalty digital currency may be sent on Layer 2 of the blockchain protocol, as an example, for speed and lack of expense. The auction may then resume by receiving new transaction requests (e.g., step 300) and/or forming a new block from already received requests and/or digests (e.g., step 304).

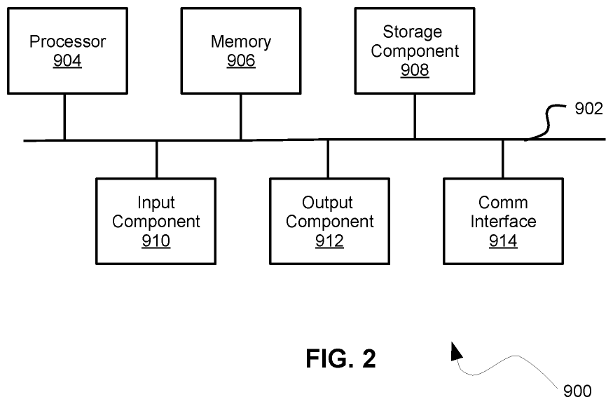

Referring now to FIG. 2, shown is a diagram of example components of a device 900 according to non-limiting embodiments. Device 900 may correspond to the operator 100 in FIG. 1, as an example. In some non-limiting embodiments, such systems or devices may include at least one device 900 and/or at least one component of device 900. The number and arrangement of components shown are provided as an example. In some non-limiting embodiments, device 900 may include additional components, fewer components, different components, or differently arranged components than those shown in FIG. 1. Additionally, or alternatively, a set of components (e.g., one or more components) of device 900 may perform one or more functions described as being performed by another set of components of device 900.

As shown in FIG. 2, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 2, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed to” or “configured to,” as used herein, may refer to an arrangement of software, device(s), and/or hardware for performing and/or enabling one or more functions (e.g., actions, processes, steps of a process, and/or the like). For example, “a processor programmed to” or “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method comprising:
communicating, with at least one processor, a plurality of digests to each mining node of a plurality of mining nodes in a blockchain network, each digest of the plurality of digests generated based on a transaction request comprising transaction data without including the transaction data in each digest;
receiving, with the at least one processor from at least one mining node of the plurality of mining nodes, block data generated based on a proof-of-work protocol and at least a portion of digests of the plurality of digests;
requesting, with the at least one processor, the transaction data for each transaction request of a plurality of transaction requests corresponding to the at least a portion of digests; and
publishing, with the at least one processor, a new block to the blockchain network based on the transaction data and the block data.

2. The method of claim 1, further comprising:
receiving, with the at least one processor, a plurality of transaction requests; and
generating the plurality of digests based on the plurality of transaction requests.

3. The method of claim 2, further comprising:
determining a subset of transaction requests of the plurality of transaction requests based on a plurality of bids associated with the plurality of transaction requests, each digest of the plurality of digests corresponding to a transaction request of the subset of transaction requests.

4. The method of claim 1, wherein the at least one mining node is a single mining node.

5. The method of claim 1, wherein the transaction data is requested for each transaction request in response to receiving the block data generated based on the proof-of-work protocol.

6. The method of claim 1, further comprising:
allocating a reward to an address corresponding to the at least one mining node in response to receiving the block data generated based on the proof-of-work protocol.

7. The method of claim 6, wherein the reward is allocated as a Layer 2 transaction on the blockchain network.

8. The method of claim 1, further comprising:
in response to a transaction requestor cancelling a transaction request, issuing a penalty to the transaction requestor.

9. A system comprising at least one processor programmed or configured to:
communicate a plurality of digests to each mining node of a plurality of mining nodes in a blockchain network, each digest of the plurality of digests generated based on a transaction request comprising transaction data without including the transaction data in each digest;
receive, from at least one mining node of the plurality of mining nodes, block data generated based on a proof-of-work protocol and at least a portion of digests of the plurality of digests;
request the transaction data for each transaction request of a plurality of transaction requests corresponding to the at least a portion of digests; and
publish a new block to the blockchain network based on the transaction data and the block data.

10. The system of claim 9, the at least one processor further programmed or configured to:
receive a plurality of transaction requests; and
generate the plurality of digests based on the plurality of transaction requests.

11. The system of claim 10, the at least one processor further programmed or configured to:
determine a subset of transaction requests of the plurality of transaction requests based on a plurality of bids associated with the plurality of transaction requests, each digest of the plurality of digests corresponding to a transaction request of the subset of transaction requests.

12. The system of claim 9, wherein the at least one mining node is a single mining node.

13. The system of claim 9, wherein the transaction data is requested for each transaction request in response to receiving the block data generated based on the proof-of-work protocol.

14. The system of claim 9, wherein the at least one processor is further programmed or configured to:
allocate a reward to an address corresponding to the at least one mining node in response to receiving the block data generated based on the proof-of-work protocol.

15. The system of claim 14, wherein the reward is allocated as a Layer 2 transaction on the blockchain network.

16. The system of claim 9, wherein the at least one processor is further programmed or configured to:
in response to a transaction requestor cancelling a transaction request, issue a penalty to the transaction requestor.

17. A computer program product comprising at least one non-transitory computer-readable medium including program instructions that, when executed by at least one processor, cause the at least one processor to:
communicate a plurality of digests to each mining node of a plurality of mining nodes in a blockchain network, each digest of the plurality of digests generated based on a transaction request comprising transaction data without including the transaction data in each digest;
receive, from at least one mining node of the plurality of mining nodes, block data generated based on a proof-of-work protocol and at least a portion of digests of the plurality of digests;
request the transaction data for each transaction request of a plurality of transaction requests corresponding to the at least a portion of digests; and
publish a new block to the blockchain network based on the transaction data and the block data.

18. The computer program product of claim 17, wherein the at least one processor is further programmed or configured to:
receive a plurality of transaction requests; and
generate the plurality of digests based on the plurality of transaction requests.

19. The computer program product of claim 18, wherein the at least one processor is further programmed or configured to:
determine a subset of transaction requests of the plurality of transaction requests based on a plurality of bids associated with the plurality of transaction requests, each digest of the plurality of digests corresponding to a transaction request of the subset of transaction requests.

20. The computer program product of claim 17, wherein the at least one mining node is a single mining node.
